(19) United States
(12) Patent Application Publication
(10) Pub. No.: US 2009/0251036 A1
(43) Pub. Date: Oct. 8, 2009

(54) Household Device Comprising an Anti-Jamming Door

(75) Inventors: Karl-Friedrich Laible, Langenau (DE); Helmut Steichele, Lauingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/085,652

(22) PCT Filed: Oct. 13, 2006
(86) PCT No.: PCT/EP2006/067393

§ 371 Date: May 27, 2008

(30) Foreign Application Priority Data
Nov. 30, 2005 (DE) 10 2005 057 133.6

(51) Int. Cl. E06B 7/16; A47B 96/00

(52) U.S. Cl. 312/326; 49/475.1; 49/493.1

(57) ABSTRACT

A household device comprising a body, a door which is connected to the body in order to close an inner chamber of the body, a superimposed decorative plate which is arranged at a distance from the door by means of a gap and a flexible cover element which extends from a lateral wall of the body until the gap and which is maintained in the gap on at least one support part which connects the door and a decorative plate.

The present invention relates to a household device, in particular a refrigeration device, comprising a body, a door which is connected to the body in order to close an inner chamber of the body and a superimposed decorative plate which is arranged at a distance from the door by means of a gap. Such household devices are used particularly as built-in devices, inserted into a furniture recess or are also used as large floor-standing devices installed close to furniture or other household devices. The decorative plate usually blends in with design elements of the adjacent furniture or household devices, in order to give the overall arrangement an aesthetically harmonized appearance.

With an arrangement of this kind, it is usually considered important for the front of the furniture and of the household devices to form a flush surface. To be able to open the door of a household device of this kind without striking adjacent furniture or devices, multi-link hinges are usually used which enable a movement of the door similar to a rotation about an imaginary axis arranged laterally at a distance from the body. A consequence of this movement is that when the door is being opened a gap, which can reach a width of several centimeters, forms between the edge of the door at the hinge end and the front of an adjacent item of furniture or household device. A finger in this gap while the door is being closed is at risk of being seriously injured.

In order to remove this danger, the applicant has proposed, in the unpublished German Patent Application 10 2004 062 238.8, a built-in household device which has a flexible plate element which on the one hand is mounted in the area of the door and on the other hand is attached in a transition area between the furniture body of the built-in household device and an adjacent second furniture body, in such a way that it covers the gap over its complete length.

According to a first embodiment, it is proposed that the cover element be attached to a side edge of the decorative plate superimposed on the domestic device door.

However, this still leaves a front edge of the cover element still visible even when the door is closed, which can be considered aesthetically unsatisfactory. According to a second embodiment, an edge area of the flexible cover element, which can slide, interposes in a gap between the household device door and the superimposed decorative plate. This makes the fitting of the decorative plate to the door difficult because the edge at the hinge side cannot be used to mount supporting parts for the decorative plate. Especially for floor-standing devices of considerable height, this can become a problem because vibration of the decorative plate cannot be ruled out.

The object of the invention is to provide a household device of the aforementioned type whose door offers an effective anti-jamming protection without at the same time impairing the appearance of the device or the stability of the decorative plate.

The object is achieved by a household device with a body, a door which is connected to the body in order to close an inner chamber of the body, a superimposed decorative plate which is arranged at a distance from the door by means of a gap and a flexible cover element which extends from a side wall of the body to the gap, with the cover element being held in the gap on a support part which connects the door and the decorative plate.

According to a preferred embodiment, the cover element is clamped in a groove formed between the support part and the decorative plate.

In order to improve the strength of the anchorage of the cover element, the support part can be provided with projecting claws which engage in the groove.

The support part is preferably an attaching bracket, the first of whose two legs is held on a back of the decorative plate and the second of which is attached to an edge of the door, especially the edge of the door at the hinge side. The same type of attaching bracket can, of course, also be used to attach the decorative plate to the edge of the door facing away from the hinge, but in this case no cover element is provided in the groove between the decorative plate and the attaching bracket.

The two legs of the attaching bracket are preferably connected by an intermediate section arranged at a distance from the decorative plate, which section together with the decorative plate forms the boundary of the groove for clamping the cover element.

A clip, attached to the decorative plate, in which the first leg of the attaching bracket is inserted into the gap, enables a particularly simple attachment of the decorative plate to the door and an adjustment of the decorative plate in the insertion direction, i.e. in the direction of the width of the door.

With the door closed, the cover element preferably forms an angle with a first leg engaging in the gap and a second leg lying against the side wall. The two legs preferably strike against each other at a point which is at the height of a side edge of the decorative plate.

The two legs are preferably connected by means of a foil hinge. In particular, it is thus possible to realize the cover element as a single piece, preferably as an extruded profile of flexible plastic.

Furthermore, it is advantageous if the second leg has a first section with a first thickness extending from the decorative plate to the body and a section with a second thickness extending along the sidewall, with the second thickness being greater than the first thickness.

The area of the cover element that blocks the gap between the door and the adjacent front of the furniture when the door is opened can thus have sufficient rigidity to ensure that it cannot be inadvertently pushed aside by a finger and on the other hand the section with the second thickness is kept sufficiently flexible for the cover element to deform in response to the movement of the door without a significant exertion of force being necessary by the user to achieve this.

To enable a precise matching of the position of the decorative plate to the front of the adjacent furniture, the decorative plate is preferably adjustable in three spatial directions, but at least in the direction of the width of the door. The cover element should also be correspondingly adjustable in order to guarantee a secure functioning.

An adjustability of the cover element is, in a second preferred embodiment, therefore advantageously achievable in that the cover element is releasably clamped between the support part clamping jaws extending parallel to the decorative plate and a clamping part. Alternatively, it would also be conceivable for the cover element to be clamped directly between the support part and the decorative plate as in the embodiment described above, but of course in this case an excessive clamping force could lead to overstressing of the decorative plate and thus to damage to said plate.

A space-saving design is realizable if the clamping part is held pressed against a side edge of the door by bolts and the clamping part can slide relative to the support part in a direction in which an approach of the clamping part to the edge forces a simultaneous approach of the clamping jaws. If in so doing the clamping part is pulled against the edge by tightening the bolts, the cover element is clamped between the clamping jaws at the same time.

The sliding of the clamping part is preferably guided by at least a beveled surface facing towards the cover plate, which is formed by a tab of the support part extending from the edge.

The support part and the clamping part each advantageously have a base plate extending lengthwise parallel to the side edge of the door. The clamping part can then be simply held in place by at least one bolt passing through an opening in the support part.

A particularly compact design can be realized if the base plate of the clamping part has a projection on one side which engages in the opening of the support part and a recess to take a head of the bolt on the other side.

Several of the support parts can be arranged on opposite edges of the door. In this case, only the support parts on the edge at the hinge side need to be fitted with clamping parts.

Furthermore, each support part preferably has a clamp which accommodates a profile that covers the gap between the door and decorative plate.

Further features and advantages are given in the following description of exemplary embodiments, with reference to the accompanying drawings. The drawings are as follows:

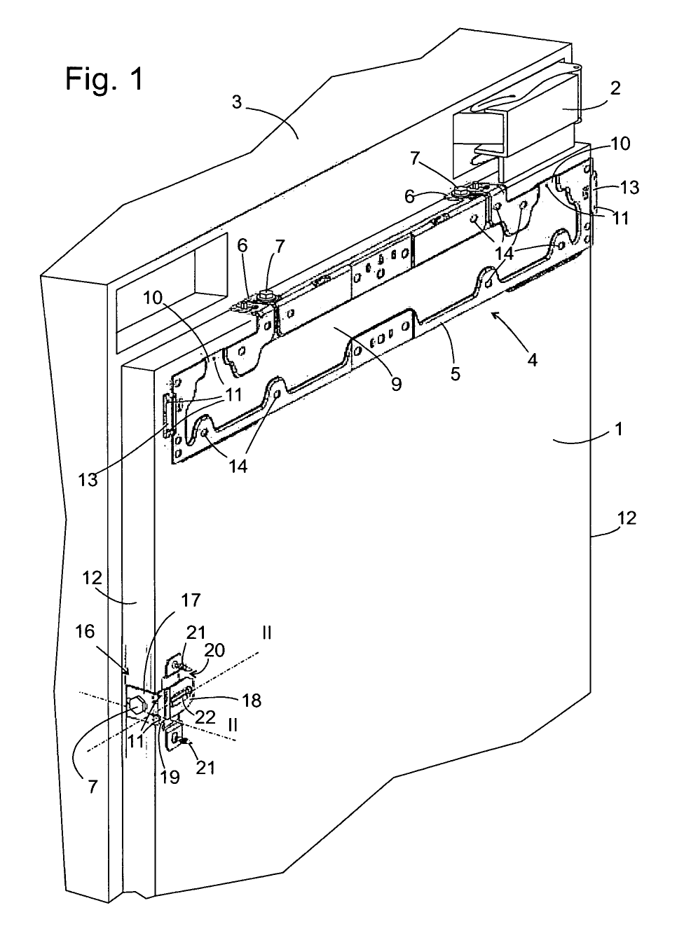

FIG. 1 A perspective view of a refrigeration device with the decorative plate removed, in order to show the door and the attaching means fitted to it for the adjustable attachment of the decorative plate to the door;

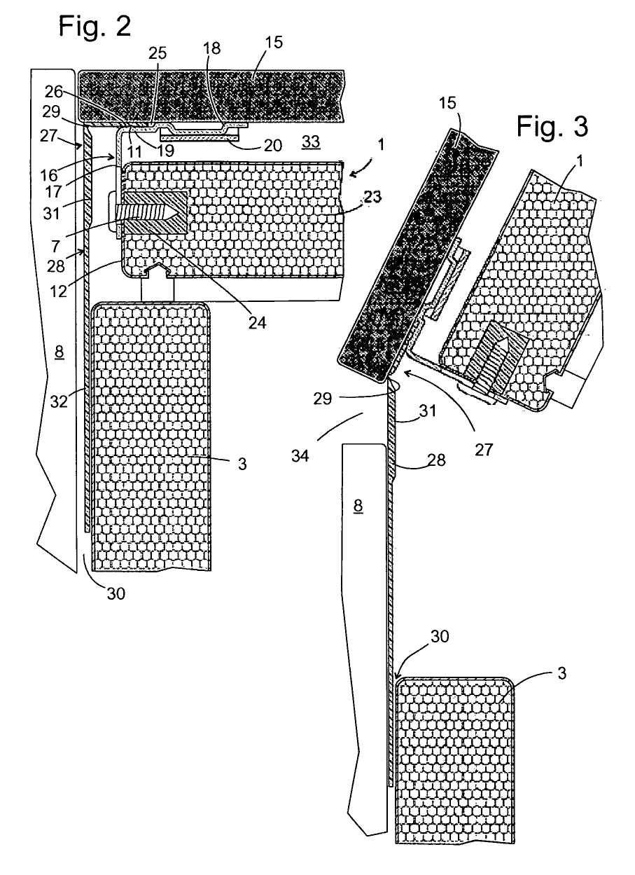

FIG. 2 A horizontal part section through the door and the decorative plate mounted thereon, in the plane defined by two lines II-II in FIG. 1, with the door closed;

FIG. 3 A section similar to FIG. 2, but with the door half open; and

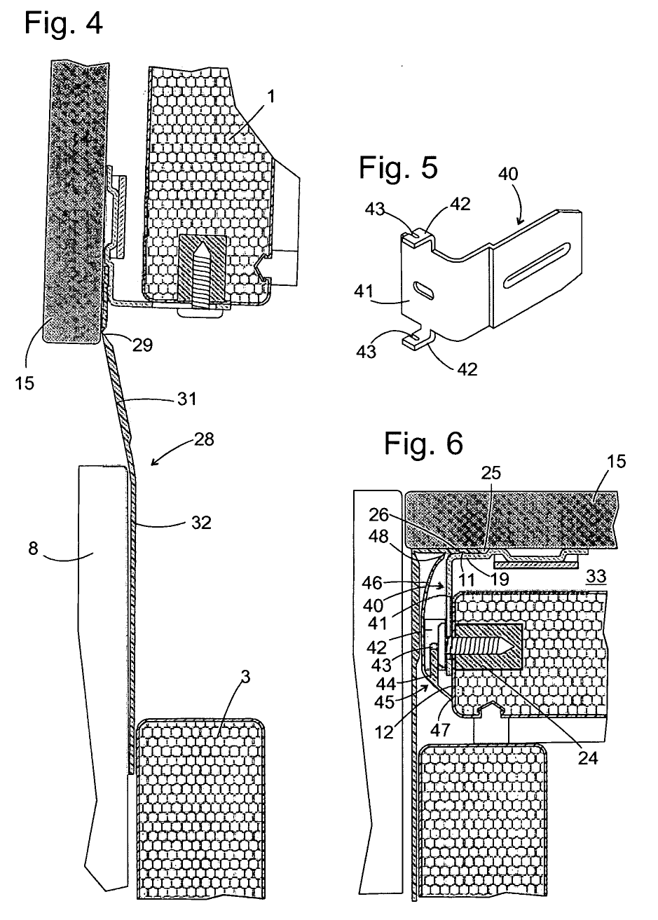

FIG. 4 A section similar to FIG. 2, with the door opened approximately at a right angle;

FIG. 5 A modified embodiment of a mounting bracket for connecting the door and decorative plate;

FIG. 6 A part section similar to FIG. 2 through a refrigeration device and an adjacent item of furniture, with the refrigeration device being fitted with the mounting bracket shown in FIG. 5;

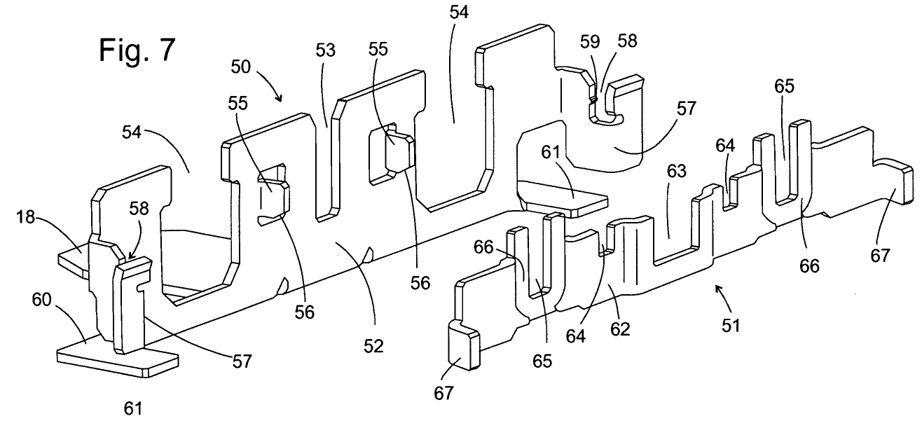

FIG. 7 A perspective view of a mounting bracket and a clamping part interacting with the mounting bracket in accordance with a further-developed embodiment of the invention;

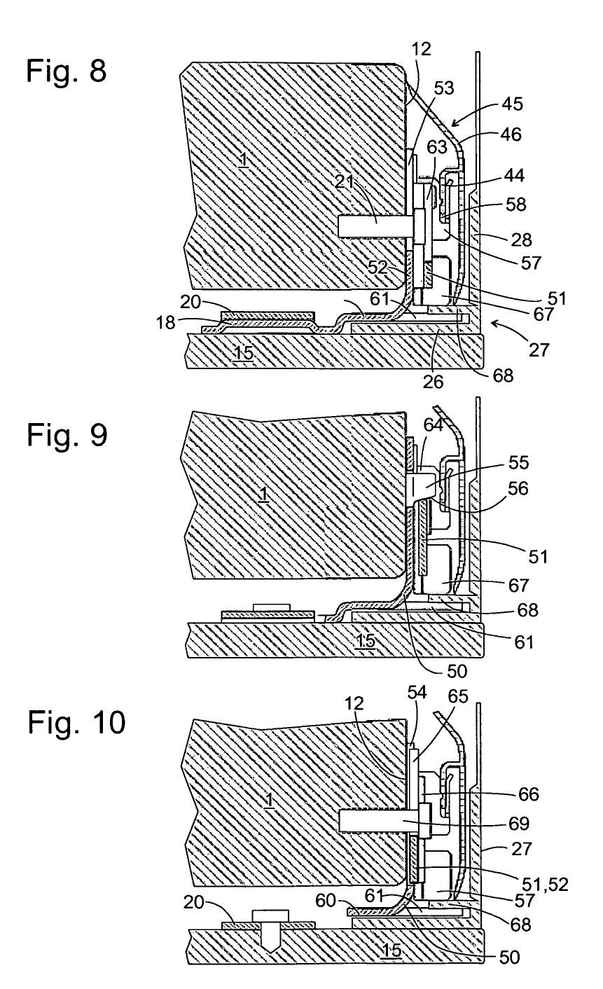

FIG. 8 to 10 Sections through the mounting bracket and the clamping part shown in FIG. 7, in a mounted state between a refrigeration device door and a decorative plate.

FIG. 1 shows a perspective view of the top front area of a household device as an exemplary embodiment for an inventive household device. The drawing shows a door 1 which is connected by a multilink hinge 2 to a body 3 of the refrigeration device. The door 1 is realized in a conventional manner with a cavity filled with an expanded-foam polymer material. In the top edge of the door 1 there are two pairs of blind threaded holes. An adjusting rail 4 has a base plate 5 essentially extending over the complete width of the door 1, and two tabs 6 bent at right angles to the base plate. Two holes, aligned with the blind threaded holes, are punched in each of the tabs 6. In a blind threaded hole of each pair is a special bolt whose head is a plate, hidden under the tab 6 in the illustration, and is larger than the hole, so that the tab is supported on said plate, and has a pin with an axial clearance from the plate, with said pin passing through the hole with a clearance and enabling the special bolt to rotate under the tab 6 and thus adjust the height of the adjusting rail or of the decorative plate attached thereto. In the other blind threaded hole is a bolt 7 which holds the tab 6 pressed against the plate and thus fixes the adjusting rail 4 on the door 1. The base plate 5 is stiffened by a flat embossed rib 9 from which fingers extend into the tab 6.

On the side edges of the base plate 5 adjacent to the side edges 12 of the door 1, two tabs 13 are angled from the plane of the base plate 5 towards the door 1 and are provided with embossed claws 11.

A plurality of holes 14 is provided in the base plate 5 in order to attach a decorative plate 15 to the base plate with the help of inserted bolts. When this has been done, the tabs 13, together with the opposite decorative plate 15 in each case, form insertion grooves, open towards the edges 12 of the door 1, into which the claws 11 project.

Several mounting brackets 16, formed from a strong plate as a single piece with the adjusting rail 4 are in each case attached by a bolt 7 to the side edges 12 of the door plate 1 at the device end, with the bolt 7 passing through an elongated hole in a first leg 17 of the bracket and engaging in a blind threaded hole on the edge 12. A second leg 18 of the bracket 16 can be fixed at an adjustable clearance from the door 1 by sliding the elongated hole relative to the bolt 7. Between the two legs 17, 18 an intermediate section 19, from which again two claws 11 project, is formed at the mounting bracket, offset from, and parallel to, the second leg 18.

A clip 20 shown in the illustration behind the second leg 18 and also formed from a plate is not permanently connected to the mounting bracket 16 but is instead provided in order to be attached to the decorative plate 15 with the aid of two bolts 21, and to thus form a slot between a center section of the clip 20 and the decorative plate 14 into which the second leg 18 can be slid from the side and then engage. A bead 22 formed in the second leg 18 facilitates the creation of a friction connection between the second leg 18 and the slot when the leg 18 is inserted in said slot.

FIG. 2 shows a part section through a front corner of the refrigeration device with a part of the door 1 and a decorative plate 15, with the decorative plate 15 having a clearance from the door 1 due to the gap 33, with the section shown at the height of the mounting bracket 16 and also through an adjacent household device or item of furniture 8, whose front side is flush with the front side of the decorative plate 15 when the door 1 is in the closed position.

To provide a stronger anchorage, the blind threaded hole for the bolt 7 in the door 1 is formed by a solid plastic body 24 let in to the expanded polymer material 23 and attached to the outer skin of the door 1.

A first leg 26 of an extruded plastic profile 27 of angular cross-section is inserted into an insertion groove 25, bounded on one side by the intermediate section 19 and on the other side by the decorative plate 15 and is held by friction connection and with the aid of the claws 11 projecting into the insertion groove 25. The depth of insertion is chosen so that a foil hinge 29, which connects the leg 27 to a second leg 28, lies directly against the side edge of the decorative plate 15.

The second leg 28 extends along the edge 12 of the door 1 up to a gap 30 between the side wall of the body 3 and the adjacent item of furniture 8. The leg 28 is divided into two sections, one of which is a thick and correspondingly stiff section 31 adjacent to the foil hinge 29 and which extends from the edge 12 of the door 1 up to the body 3, and, connected to this, a thin and more flexible section 32 that engages between the body 3 and the adjacent item of furniture 8.

FIG. 3 shows the same components as in FIG. 2 but with the door 1 in a partially opened position. The movement of the door I causes the leg 28 to be partly withdrawn from the gap 30 and its stiff section 31 bridges a gap 34 which has formed between the decorative plate 15 and the item of furniture 8 due to the movement of the door 1.

The extruded profile 27 in the foil hinge 29 is easily flexible and presents no significant resistance to the opening of the door 1. The stiffness of the section 31 on the other hand effectively prevents not only an inadvertent introduction of fingers into the gap 34 but also effectively prevents a small child, who would be unaware of the danger, from sticking his finger intentionally into the gap 34.

When the door 1 is opened further, as shown in FIG. 3, the decorative plate 15 then moves in a sideways direction in front of the adjacent item of furniture 8. This state is shown in FIG. 4.

The width of the section 31 is designed so that when the foil hinge 29 moves in front of the item of furniture 8 the thin section 32 has reached the front corner of the item of furniture 8, so that when the foil hinge 29 moves in a sideways direction in front of the item of furniture 8 the leg 28 can accommodate it, in that the front area of the section 32 bends. The design of the leg 28 consisting of different thicknesses and different stiffnesses of sections 31 and 32 gives the leg 28 a high degree of stiffness overall, which ensures that it reliably moves back into the gap 30 when the door 1 is closed. There is no danger of the leg sticking and then buckling between the item of furniture 8 and the edge 12 of the door 1.

FIG. 5 shows a mounting bracket 40 which differs from the mounting bracket 16 of the embodiment described with reference to FIGS. 1 to 4 in that there are two angled tabs 42 on its leg 41 parallel to the side edge 12 of the door 1. The tabs 42 are each provided with a notch 43 open towards the free end of the leg 41.

As can be seen in FIG. 6, the section through a refrigeration device with the mounting bracket 40 similar to FIG. 2 shows that the notches 43 serve to hold clamped a web 44 of a flexible cover profile 45. The web 44 forms a single piece with an outer cover 46 which extends in a curve around the leg 17 and with one rim 47 touching the edge 12 of the door and with the opposite rim 48 touching the leg 26 of the angle profile 27, and in this way covering the gap 33 between the door 1 and the decorative plate 15.

A side edge of the door 1, not illustrated, opposite the edge 12 is connected in a similar manner to the decorative plate 15 by means of mounting brackets 40. In this case also the cover profile 45 is inserted into the notches 43 of the mounting bracket 40 in order also to close the gap 33 on this side with in this case the front rim 48 of the outer cover 46 directly contacting the decorative plate 15.

FIG. 7 shows a perspective view of a mounting bracket 50 and a clamping part 51 designed to interact with the mounting bracket 50, in accordance with a further-developed embodiment of the invention. Similar to the mounting brackets 16, 40, the mounting bracket 50 is also provided with a leg 18 in order that it can be pushed between the decorative plate 15 and a clip attached thereto, similar to the clip 20 in FIG. 1.

The other leg is widened to form an elongated plate 52 in which three cutouts 53, 54, 54, opened out to the edge are formed. Two tabs 55 are notched out of the plate on both sides of the central cutout 53. A beveled surface 56 is formed in each case on a bottom edge of the tabs 55 facing towards the decorative plate 15 when the mounting bracket 50 is fitted.

Two arms 57 each with a notch 58 open upwards are bent out from the long ends of the plate 52. A latching projection or opposing hook 59 is provided in the notch 58 on both arms 57.

An intermediate section 60, which in the illustration is largely hidden behind the plate 52, is attached at right angles to the bottom edge of the plate 52 shown in FIG. 7. As with the mounting bracket 16, the intermediate section and the leg 18 are separated by an offset, so that when the leg 18 lies against the decorative plate 15 a gap is present between the decorative plate 15 and the intermediate section 60. Two tongues 61 that extend underneath the angled arms 57 are formed on the long ends of the intermediate section 60.

The clamping part 51 is, the same as the mounting bracket 50, stamped out of a sheet and then shaped. Five cutouts 63, 64, 64, 65, 65 open at the top are formed in an elongated base plate 62 of the clamping part 51. The wide central cutout 63 is aligned with the cutout 53 of the mounting bracket 50; the two small cutouts 64 adjacent to this are provided in order to accommodate the tabs 55 of the mounting bracket, and the outer cutouts 65 are aligned with the cutouts 54 of the mounting bracket. The cutouts 65 are formed in a U-shaped recess 66 of the base plate 62 and a projection on the back of the base plate 62 corresponding to the recess 66 engages in the cutouts 54 of the mounting bracket in the installed state.

Two short angled arms 67 are provided on the long ends of the base plate 62.

FIG. 8 is a section along a plane running through the central sections 53, 63 showing the mounting bracket 50 and the clamping part 51 in the installed state on the refrigeration device door 1. The head of a bolt 21 which crosses the cutout 53 and is anchored in the door 1 holds the plate 52 pressed against the edge 12. The head of the bolt 21 is accommodated in the wide cutout 63 of the clamping part 51 without touching the clamping part 51. The leg 18 of the mounting bracket 50 engages between the decorative plate 15 and a clip 20 attached to said decorative plate 15. The decorative plate 15 can be adjusted in the width direction relative to the door 1 by sliding the leg 18 in the gap formed between the clip 20 and the decorative plate 15.

As in the embodiment shown in FIG. 2, a flexible extruded profile 27 has a leg 26 engaging between the decorative plate 15 and the intermediate section 60, and a leg 28 which extends from the edge of the decorative plate 15 to a gap between the body (not illustrated) of the refrigeration device and an adjacent item of furniture or appliance. A web 68 of the extruded profile 27 parallel to the leg 26 is clamped between the arms 67 of the clamping part 51 and the opposite tongues 61 of the mounting bracket 50. Because this clamping provides a firm retention of the profile 27, the leg 26 itself does not need to be clamped and is preferably accommodated with a slight clearance between the decorative plate 15 and the intermediate section 60.

In a similar manner, as shown in FIG. 6, a web 44 of a cover profile 45 is inserted into the notches 58 of the arms 57 and an outer cover 46 of the cover section 45 extends between the edge 12 of the door 1 and the web 68 and thus conceals the mounting bracket 50, the clamping part 51 and the gap between the door 1 and the decorative plate 15.

FIG. 9 shows a second section through the mounting bracket 50, the clamping part 51 and their environment along a plane running through one of the cutouts 64. The tab 55 engages in the cutout 64, with the web 68, clamped between the tongue 61 and the arm 67, holding the bottom edge of the cutout 64 resiliently against the beveled surface 56 on the underside of the tab 55 so that the clamping part can slide along a path defined by the orientation of the beveled surface 56.

FIG. 10 shows a third section through the mounting bracket 50 and the clamping part 51 in a plane running through a pair of cutouts 54, 65. A bolt 69 passes through the cutouts 54, 65 and is anchored in the door 1. The head of the bolt 69 lies within the recess 66 on the plate 52 and holds the clamping part 51 pressed against the edge 12 of the door. A projection, opposite the recess 66, on the side of the plate 52 facing towards the door is engaged in the cutout 54. The projection does not directly contact the edge 12. When the bolt 69 is tightened in order to move the plate 52 closer to the edge 12, the plate 52 is at the same time forced downwards on the beveled surfaces 56 of the tabs 55, so that the gap between the arm 57 and the tongue 61, in which the web 68 is clamped, is narrowed, This means that with the aid of the beveled surfaces 56 the clamping part 51 can slide in a guided movement to the edge 12 and at the same time to the decorative plate 15, so that by tightening the two bolts 69 passing through the two pairs of cutouts 54, 65 the extruded profile 27 is tightly clamped and the extruded profile 27 can be released by loosening the bolts 69. It is thus possible after adjustment of the decorative plate 15 relative to the door 1 to position the extruded profile 27 exactly so that the outside of its leg 28 is flush with the edge of the decorative plate 15.

1-18. (canceled)

19. A household device comprising:
a body; the body having a side wall and an inner chamber;
a door connected to the body for opening and closing the inner chamber of the body;
a superimposed decorative plate' at the decorative plated located a distance from the door thereby forming a gap'
a flexible cover element extending from the side wall of the body into the gap;
at least one support part connecting the door and decorative plate; the cover element held in the gap on the support part.

20. The household device as claimed in claim 19, further including a groove formed between the support part and the decorative plate; the cover element clamped in the groove.

21. The household device as claimed in claim 20, wherein the support part includes claws projecting into the groove.

22. The household appliance as claimed in claim 19, wherein the door includes an edge; the support part is a mounting bracket having first and second legs; the first leg being held on a back of the decorative plate and the second leg being attached to an edge of the door.

23. The household device as claimed in claim 22, wherein the mounting bracket includes an intermediation section; the first and second legs are connected by the intermediate section a distance from the decorative plate' the intermediate section together with a decorative plate forming the boundary of the groove.

24. The household device as claimed in claim 22, further including a clip attached to the decorative plate; the first leg being inserted into the gap.

25. The household device as claimed in claim 19, wherein the flexible cover element includes first and second legs; the cover element forming an angle when the door is closed; wherein the first leg of the cover element engages in the gap and the second leg of the cover element being against the side wall.

26. The household device as claimed in claim 25, wherein the first and second legs of the cover element are connected by a foil hinge.

27. The household device as claimed in claim 25, wherein the second leg of the cover element has a first section with a first thickness extending from the decorative plate to the body and a second section with a second thickness extending along the side wall, wherein the second thickness is greater than the first thickness.

28. The household device as claimed in claim 19, wherein the decorative plate and the cover element are adjustable relative to the support part at least in the direction of the width of the door.

29. The household device as claimed in claim 28, further including a carrier part and a clamping part; the carrier part having clamping jaws; the cover element being releasably clamped between clamping jaws of the carrier part and of the clamping part extending parallel to the decorative plate.

30. The household device as claimed in claim 29, wherein the clamping part is held pressed by bolts against a side edge of the door and the clamping part slides guided relative to the support part in a direction in which an approach of the clamping part to the edge forces a simultaneous approach of the clamping jaws.

31. The household device as claimed in claim 30, further including a beveled surface facing towards the cover plate which is formed by a tab of the support part extending out from the edge.; the sliding of the clamping part being guided at least by the beveled edge

32. The household device as claimed in one of claims 29, wherein the support part and the clamping part each have a base plate extending lengthwise parallel to a side edge of the door and that the clamping part may be simply held on the edge by at least one bolt passing through an opening in the support part.

33. The household device as claimed in claim 32, wherein the base plate of the clamping part includes a projection on one side which engages in the opening of the support part and a recess on the other side to receive a head of the bolt.

34. The household device as claimed in claim 19, further including a plurality of support parts; at least some of the support parts are arranged on opposite edges of the door.

35. The household device as claimed in claim 34, wherein each support part includes a clamp for holding the profile covering the gap.
